(19) United States
(12) Patent Application Publication
(10) Pub. No.: US 2022/0366375 A1
(43) Pub. Date: Nov. 17, 2022

(54) SYSTEM AND METHOD FOR AGENT INACTIVITY PREDICTION AND WORK TIME RECONCILIATION

(71) Applicant: Nice Ltd., Ra'anana (IL)

(72) Inventors: Niranjan Bagade, Kothrud (IN); Tanmay Patwardhan, Pune (IN); Vaibhav Chobe, Pune (IN)

(21) Appl. No.: 17/316,747

(22) Filed: May 11, 2021

(51) Int. Cl. G06Q 10/10

(52) U.S. Cl. CPC G06Q 10/1091; G06Q 10/1093

(57) ABSTRACT

A computerized-method for work-time reconciliation upon agent inactivity prediction is provided herein. In a computerized system that includes a processor, a data storage of data related to workforce-management and a data storage of data relate to interaction-routing and a memory to store the data storages, the processor operating a work-time reconciliation module. The operating of the work-time reconciliation module includes operating an agent inactivity detection module to yield a list of agents for work-time reconciliation and then, storing the list of agents for work-time reconciliation in the data storage of data related to workforce management and then displaying on a display unit details of agents in the list of agents for work-time reconciliation.

### TECHNICAL FIELD

The present disclosure relates to the field of data analysis and more specifically to work time reconciliation upon agent inactivity detection in a workforce management related system.

### BACKGROUND

In contact centers, the term “adherence” refers to the availability of an agent during a scheduled shift to handle interactions, or after call wrap and other scheduled activities, such as meetings and training. Commonly, workforce management systems track all the activities or activity states of an agent during a scheduled shift. For example, activity states, such as login, on-call, bio-break, lunchbreak, logout and the like.

Administrative issues may arise when an agent forgets to logout of the system after the agent's schedule, i.e., agent's shift is completed. This manual error of the agent, i.e. failure to logout of the system, may harm the ability of the system to determine the duration of the actual agent activity, which is further utilized for calculating agent's work hours and billing.

There may be other implications to the incapability of the system to handle this logout failure scenario, which may lead to issues related to the supervisors in the contact center. When multiple agents forget to logout daily, it is difficult for supervisors to determine whether the problem is a human error, i.e., agent logout failure or whether the workforce management system is not operating properly or as expected and therefore should be fixed. Also, the operation of correcting the data of the agents and determining the exact time of the agent logout, to prevent billing issues, may be time consuming for users such as the supervisors of the agents.

The current incapability of the system in the contact center to handle this logout failure scenario, may also lead to issues, which are related to the contact center itself. For example, incorrect agent's hours report, may damage the contact center billing, as agents are paid on an hourly basis. In another example, the staff in the contact center may require technical support for resolution from the system's provider. In yet another example, contact centers may need to include this logout failure scenario during training of their agents and with a growing number of agents, this problem may worsen.

Accordingly, there is a need for a technical solution that will handle logout failure of agents and perform work time reconciliation in a system such as the workforce management system upon agent inactivity detection.

### SUMMARY

There is thus provided, in accordance with some embodiments of the present disclosure, a computerized-method for work-time reconciliation upon agent inactivity prediction.

Furthermore, in accordance with some embodiments of the present disclosure, in a computerized system that includes a processor, a data storage of data related to workforce-management and a data storage of data relate to interaction-routing and a memory to store the data storages, the processor may be configured to operate a work-time reconciliation module.

Furthermore, in accordance with some embodiments of the present disclosure, the operating of the work-time reconciliation module may include: (i) operating an agent inactivity detection module to yield a list of agents for work-time reconciliation; (ii) storing the list of agents for work-time reconciliation in the data storage of data related to workforce management and (iii) displaying on a display unit, details of agents in the list of agents for work-time reconciliation.

Furthermore, in accordance with some embodiments of the present disclosure, the operating of the work-time reconciliation module, may further include: correcting a logout-time of each agent in the list of agents for work-time reconciliation in the data storage of data related to workforce management based on agent schedule details. The agent schedule details are retrieved from the data storage of data related to work-force management. The agent activity state may be marked as ‘logout’ at the agent's schedule end-time, based on the agent schedule details.

Furthermore, in accordance with some embodiments of the present disclosure, the operating of the agent inactivity detection module may include: (i) operating a service provider module to receive a list of agents which are out of adherence and (ii) operating an eligibility checker module for each agent in the list of agents which are out of adherence, to yield the list of agents for work-time reconciliation.

Furthermore, in accordance with some embodiments of the present disclosure, the operating of the service provider module may include: (i) collecting agents schedule of a preconfigured period of time; (ii) retrieving for each agent related to the collected agents schedule a real-time activity state; and (iii) checking adherence of each agent related to the collected agents schedule, based on the retrieved real-time activity state to yield the list of agents which are out of adherence.

Furthermore, in accordance with some embodiments of the present disclosure, the checking adherence of each agent related to the collected agents schedule based on the retrieved real-time activity state is performed by comparing the real-time activity state of each agent to at least one of activity states: ‘on-call’, ‘login’, ‘bio-break’, ‘lunchbreak’, ‘logout’, ‘meeting’, ‘after call work’, ‘call ended’, ‘call on hold’, ‘email’. ‘chat’, ‘training’, ‘call transfer’, ‘available’, ‘inbound call’, ‘outbound call’ and any other activity state.

Furthermore, in accordance with some embodiments of the present disclosure, the operating of the eligibility checker module may include: (i) checking each agent in the list of agents which are out of adherence to yield a list of agents which are out of adherence more than a preconfigured threshold amount of time; (ii) checking each agent in the list of agents which are out of adherence more than a preconfigured threshold amount of time, to yield a list of agents that their schedule has ended; (iii) checking each agent in the list of agents that their schedule has ended to yield a list of agents that their last real-time activity state is other than logout; and (iv) marking the agents in the list of agents that their last real-time activity state is other than ‘logout’ as included in the list of agents for work-time reconciliation.

Furthermore, in accordance with some embodiments of the present disclosure, the displayed details of agents in the list of agents for work-time reconciliation, may include at least one of: (i) agent's identification; (ii) a number of reconciliations in a predefined period of time; (iii) activity correction duration; and (iv) one or more dates of reconciliations.

There is further provided, in accordance with some embodiments of the present disclosure, a computerized-system for work-time reconciliation upon agent inactivity prediction.

Furthermore, in accordance with some embodiments of the present disclosure, the computerized-system may include: a processor, a data storage of data related to workforce-management and a data storage of data relate to interaction-routing; and a memory to store the data storages. The processor may be operating a work-time reconciliation module

Furthermore, in accordance with some embodiments of the present disclosure, the operating of the work-time reconciliation module may include: (i) operate an agent inactivity detection module to yield a list of agents for work-time reconciliation; (ii) store the list of agents for work-time reconciliation in the data storage of data related to workforce management; and (iii) display on a display unit details of agents in the list of agents for work-time reconciliation.

### BRIEF DESCRIPTION OF THE DRAWINGS

FIG. 1A schematically illustrates a high-level diagram of an agent inactivity detection module, in accordance with some embodiments of the present disclosure;

FIG. 1B schematically illustrates a high-level diagram of a reconciliation module, in accordance with some embodiments of the present disclosure;

FIG. 2 is a high-level workflow of a work-time reconciliation module, in accordance with some embodiments of the present disclosure;

FIG. 3 schematically illustrates a high-level diagram of a computerized method for work-time reconciliation upon agent inactivity prediction, in accordance with some embodiments of the present disclosure;

FIG. 4 schematically illustrates a high-level diagram of a computerized system for work-time reconciliation upon agent inactivity prediction, in accordance with some embodiments of the present disclosure; and

FIG. 5 shows an example of an agent activity reconciliation report, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

In contact centers, when agents' activity state does not reflect their scheduled activity they are considered out of adherence. For example, when an agent is scheduled for training, but the agent's activity state is ‘bio-break’, then the agent is considered out of adherence. When the agent begins a scheduled shift the activity state is ‘login’ and at the end time of the scheduled shift the agent is expected to logout of the system, which is commonly the Automatic Call Distributor (ACD) system. Commonly, another system, such as Workforce Management (WFM) system in the contact center, is managing the workforce which includes workforce planning, scheduling and calculating the agents' payouts. To calculate the working hours of the agents, the WFM system uses the login time and logout time from the ACD system.

In the aspect of work hours calculation of agents, reconciliation is a process where the duration of a scheduled shift of the agent is compared to the actual hours that the agent has worked, which may be derived from the agent's login time and logout time to the system and adjusted accordingly.

A failure of agents to logout of the system at the end of their shift, may cause contact centers issues of agent inactivity detection and reconciliation, which interrupt them to accurately calculate the agents work hours for the agents' payouts. Moreover, the contact centers may spend additional costs on agents' training to logout of the system. Therefore, there is a need for a technical solution that will actively monitor all agents activity states, in the contact center, by detecting missed agent ‘logout’ activity state in a system, such as the contact center Automatic Call Distributor (ACD) system and automatically initiate a ‘logout’ activity state for that agent in a Workforce Management (WFM) system.

Furthermore, there is a need for a technical solution that will generate periodic reports of reconciled agents' activity states with accurate agent work hours. The reconciled agents' activity states may provide fair agent payout and may reduce the manual effort, which is currently performed by a contact center user, such as a supervisor. The reduction of manual effort may save nonproductive efforts on manual correction of agent work hour calculations. Moreover, the provided Workforce Management (WFM) system may receive a reduced number of customer escalations and an improved Customer Satisfaction (CSAT) score for the (WFM) provider.

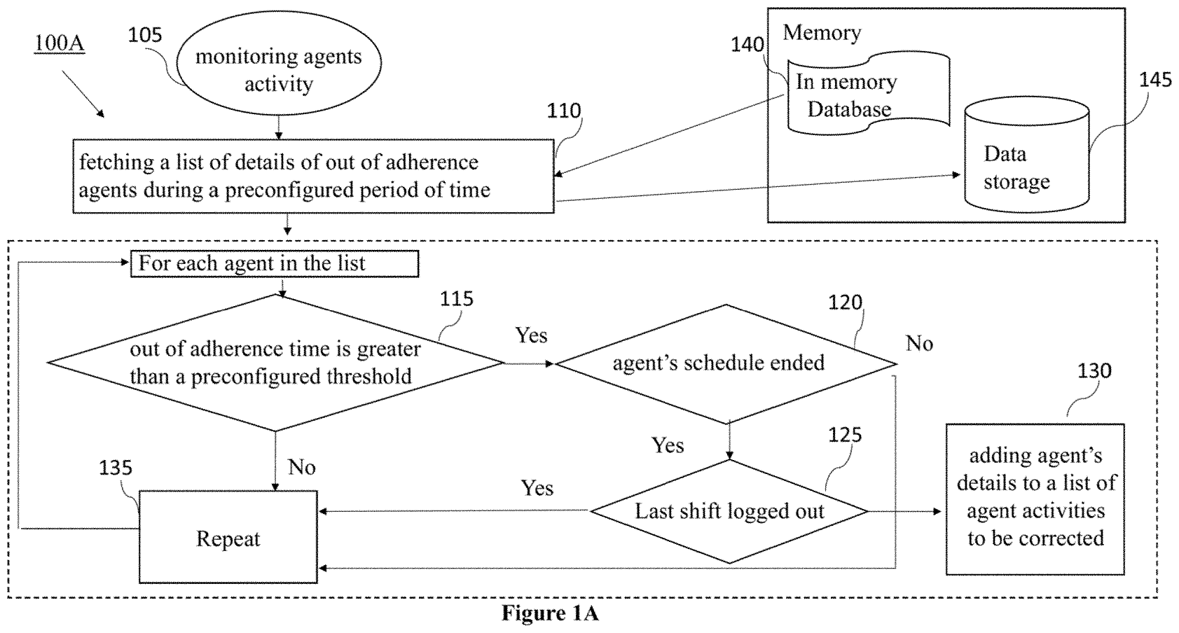

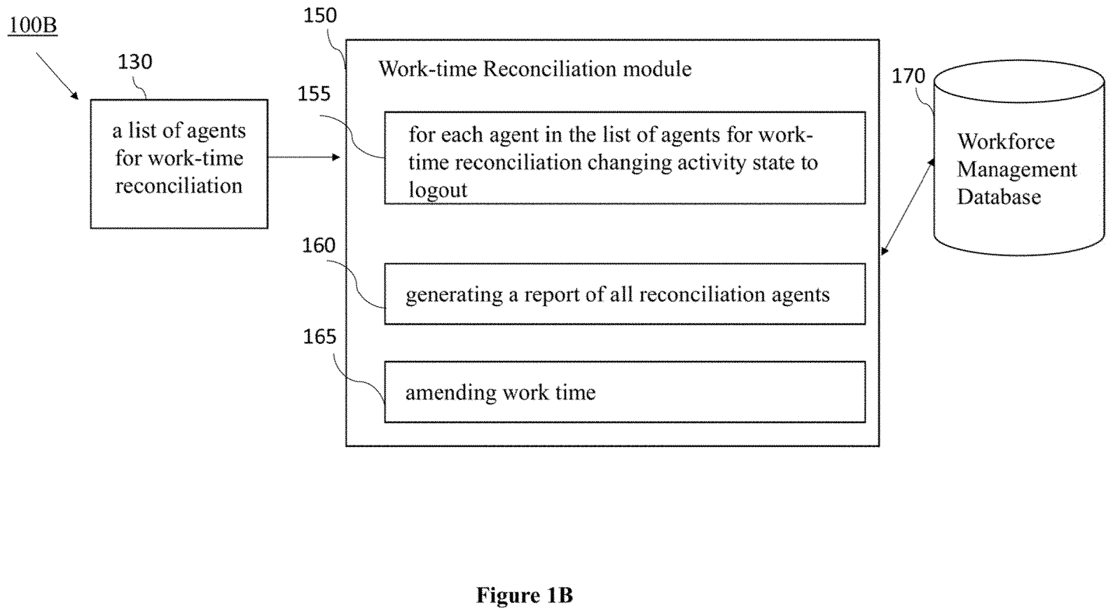

FIG. 1A schematically illustrates a high-level diagram of an agent inactivity detection module 100A, in accordance with some embodiments of the present disclosure.

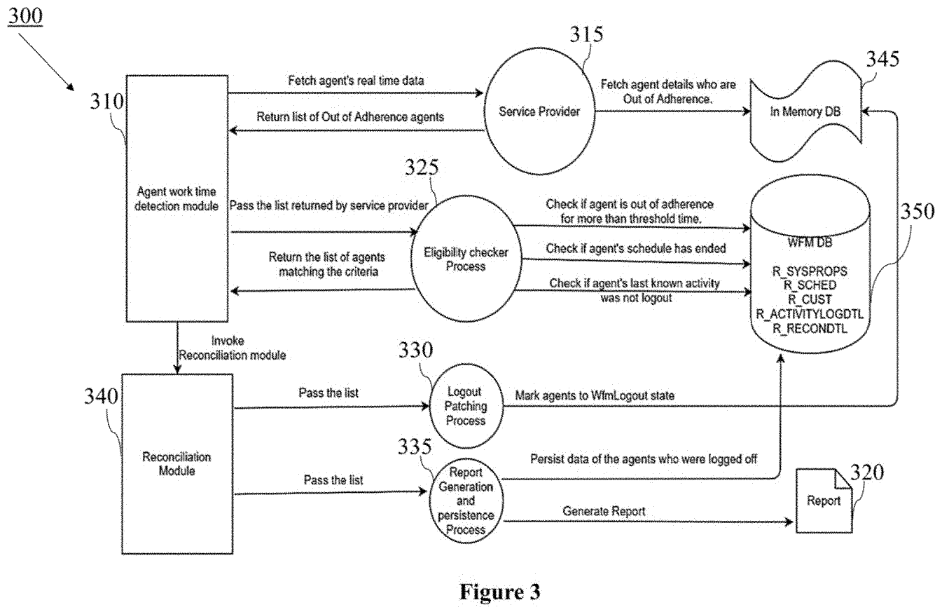

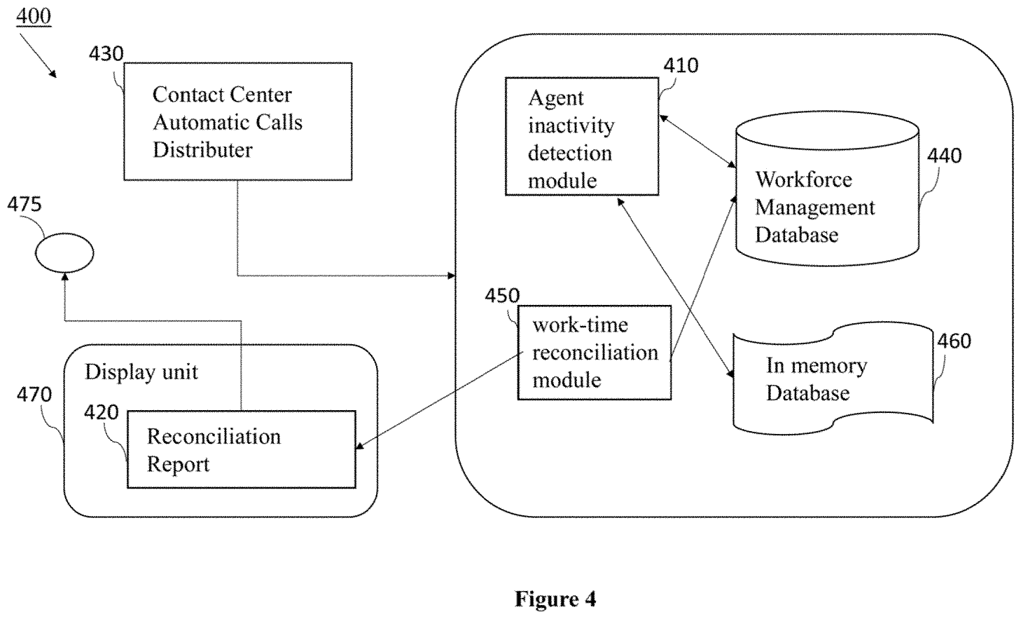

According to some embodiments of the present disclosure, an agent inactivity detection module 100A, such as agent inactivity detection module 410 in FIG. 4 or such as agent work time detection module 310 in FIG. 3, may be operated to yield a list of agents for work-time reconciliation.

According to some embodiments of the present disclosure, an agent inactivity detection module 100A, such as agent inactivity detection module 410 in FIG. 4 or such as agent work time detection module 310 in FIG. 3, may operate a service provider module, such as service provider 315 in FIG. 3, to receive a list of agents which are out of adherence. The service provider may be monitoring agents' activity 105 and fetching a list of details of out of adherence agents during a preconfigured period of time 110. The agents' activity may be stored in a data storage, such as in memory database 140, which may be associated to an Automatic Call Distributor (ACD) system which answers incoming interactions and routes them to one or more agents in a contact center. The agents' activity is later on updated in Workforce Management system and may be queried e.g., “inAdherence=false”, which indicates that agent is not adherent to the expected schedule.

According to some embodiments of the present disclosure, the operating of the service provider module, such as service provider 315 in FIG. 3, may include collecting agents schedule of a preconfigured period of time, and then, retrieving for each agent related to the collected agents schedule a real-time activity state. Then the service provider module, such as service provider 315 in FIG. 3, may check adherence of each agent related to the collected agents schedule based on the retrieved real-time activity state to yield the list of agents which are out of adherence.

According to some embodiments of the present disclosure, an agent inactivity detection module 100A, such as agent inactivity detection module 410 in FIG. 4 or such as agent work time detection module 310 in FIG. 3, may store the list of agents for work-time reconciliation in the data storage of data related to workforce management, such as data storage 145 or such as Workforce management (WFM) database 440 in FIG. 4.

According to some embodiments of the present disclosure, for each agent in the list of agents for work-time reconciliation, the agent inactivity detection may operate an eligibility checker module, such as eligibility checker process 325 in FIG. 3 to yield a list of agents for work-time reconciliation, such as the list of agents for work-time reconciliation 130 in FIG. 1B.

According to some embodiments of the present disclosure, the eligibility checker module, such as eligibility checker process 325 in FIG. 3, may check each agent in the list of agents which are out of adherence to yield a list of agents which their out of adherence duration is greater than a preconfigured threshold amount of time 115 and then may check each agent in the list of agents which their out of adherence duration is more than a preconfigured threshold amount of time to yield a list of agents that their schedule has ended 120. The agent's schedule may be derived from WFM's database where agent's start time and end time of shift may be stored and identified.

According to some embodiments of the present disclosure, the eligibility checker module, such as eligibility checker process 325 in FIG. 3, may then, check each agent in the list of agents that their schedule has ended to yield a list of agents that their last real-time activity state is other than logout 125. The last shift logged out may be derived from WFM's In Memory database, such as in memory database 140 in response to a query such as “currActCodeOid not equal to LOGOUT” which indicates that the agent didn't log out from the system that they are supposed to, such as ACD system.

According to some embodiments of the present disclosure, the eligibility checker module, such as eligibility checker process 325 in FIG. 3, may then, add agent's details in the list of agents that their last real-time activity state is other than ‘logout’ to a list of agent activities to be corrected 130, i.e., to be included in the list of agents for work-time reconciliation.

According to some embodiments of the present disclosure, the above validations of the eligibility checker module, such as eligibility checker process 325 in FIG. 3, may provide a list of agents whose scheduled shift time has ended, but still they are seen as available or working in the WFM's agent activity screen, till a configurable amount of time, for example 15 minutes or 30 minutes has passed from their end of scheduled shift time.

According to some embodiments of the present disclosure, the eligibility checker module, such as eligibility checker process 325 in FIG. 3, may send agent's details to a reconciliation module such as work-time reconciliation module 150 in FIG. 18 and work-time reconciliation module 450 in FIG. 4.

FIG. 1B schematically illustrates a high-level diagram of a reconciliation module 100B, in accordance with some embodiments of the present disclosure.

According to some embodiments of the present disclosure, a list of agents for work-time reconciliation 130 may be provided to a work-time reconciliation module, such as work-time reconciliation module 150. For each agent in the list of agents for work-time reconciliation 130, the work-time reconciliation module, such as work-time reconciliation module 150 may change the activity state to logout 155.

According to some embodiments of the present disclosure, the work-time reconciliation module, such as work-time reconciliation module 150 or such as work-time reconciliation module 450 in FIG. 4 may generate a report of all reconciliation agents 160, such as report 320 in FIG. 3 or such as reconciliation report 420 in FIG. 4.

According to some embodiments of the present disclosure, the work-time reconciliation module, such as work-time reconciliation module 150 or such as work-time reconciliation module 450 in FIG. 4 may amend the work-time of agents in the list of agents for work-time reconciliation 130, according to the end time of the agents last scheduled shift, which may be retrieved from the database, such as Workforce management database 170 and data storage 145 in FIG. 1A or such as Workforce management database 440 in FIG. 4.

For example, if an agent has received a schedule, i.e., has been scheduled work shift, that is starting at 9 AM and ending at 6 PM, then when that agent forgets to logout from the system that the agent is supposed to log out from, such as ACD system, at the end of the schedule and is off work, then the duration of the shift of the agent may be wrongly calculated.

According to some embodiments of the present disclosure, the work-time reconciliation module, such as work-time reconciliation module 150 or such as work-time reconciliation module 450 in FIG. 4 may detect as out of adherence, end of shift time and last event is not logout. When all the three conditions are satisfied for this agent, i.e., conditions 115, 120 and 125 in FIG. 1A, then the agent's activity state will be referred to as logout and agent's work time will be reconciled to reflect time when the agent is off work without logging out of the ACD system.

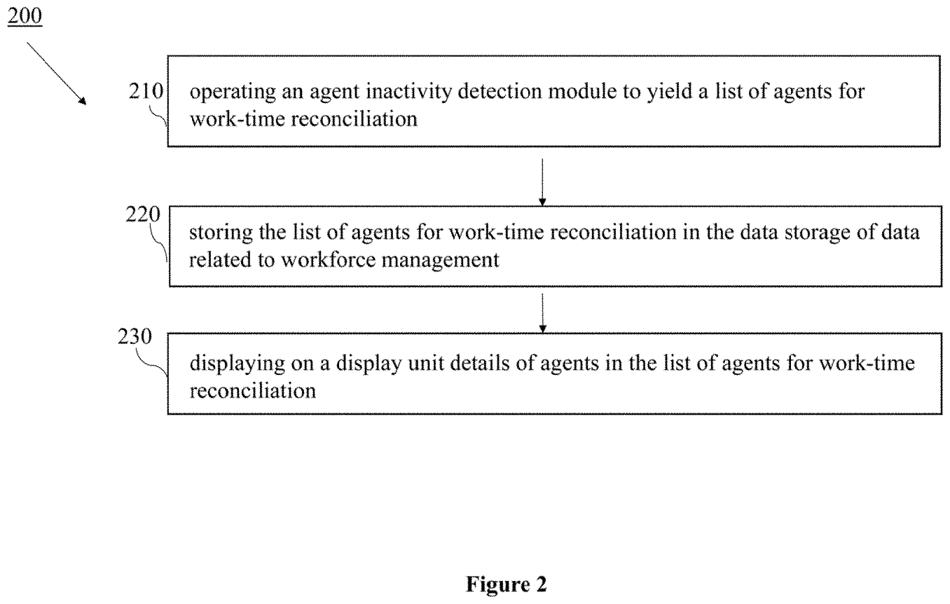

FIG. 2 is a high-level workflow of a work-time reconciliation module 200, in accordance with some embodiments of the present disclosure.

According to some embodiments of the present disclosure, operation 210 may comprise operating an agent inactivity detection module to yield a list of agents for work-time reconciliation.

According to some embodiments of the present disclosure, the agent inactivity detection module, such as agent inactivity detection module 410, in FIG. 4 may include operating a service provider module, such as service provider 315 in FIG. 3 to receive a list of agents which are out of adherence and operating an eligibility checker module, such as eligibility checker process 325 in FIG. 3 for each agent in the list of agents which are out of adherence to yield the list of agents for work-time reconciliation.

According to some embodiments of the present disclosure, operation 220 may comprise storing the list of agents for work-time reconciliation in the data storage of data related to workforce management, such as data storage 145 in FIG. 1A or such as Workforce Management database 440 in FIG. 4.

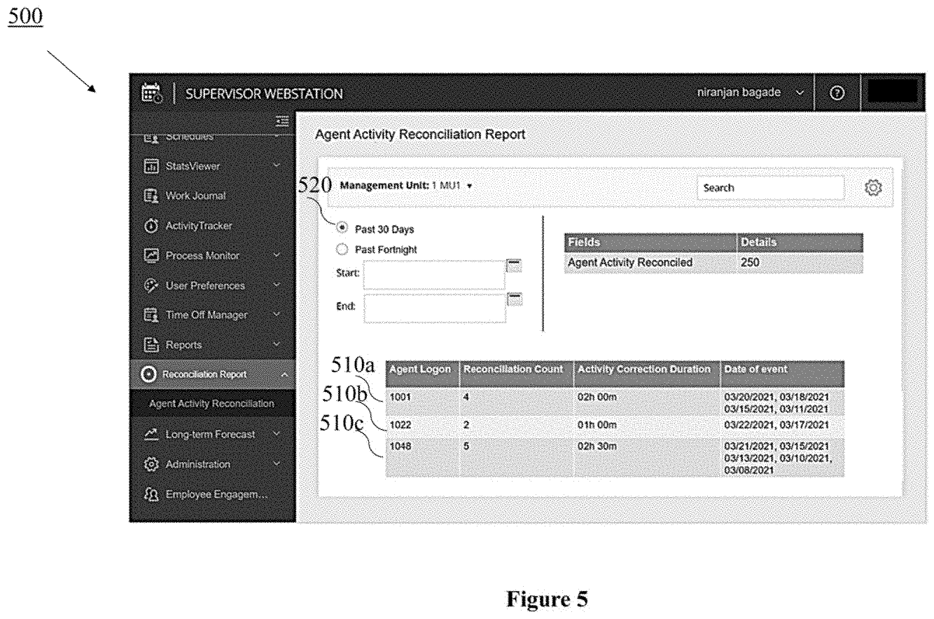

According to some embodiments of the present disclosure, operation 230 may comprise displaying, on a display unit, details of agents in the list of agents for work-time reconciliation. The list of agents for work-time reconciliation may be displayed, via a display unit, such as display unit 470 as a reconciliation report 420 or such as reconciliation report 500 in FIG. 5.

FIG. 3 schematically illustrates a high-level diagram of a computerized method 300 for work-time reconciliation upon agent inactivity prediction, in accordance with some embodiments of the present disclosure.

According to some embodiments of the present disclosure, a computerized method for work-time reconciliation upon agent inactivity prediction, such as computerized method 300 for work-time reconciliation upon agent inactivity prediction may operate an agent inactivity detection module, such as agent work time detection module 310 to yield a list of agents for work-time reconciliation.

According to some embodiments of the present disclosure, the agent inactivity detection module, such as agent work time detection module 310 may operate a service provider module, such as service provider 315 to receive a list of agents which are out of adherence. The service provider module, such as service provider 315 may fetch agent details which are out of adherence from in memory database, such as in memory database 315 by collecting agents schedule of a preconfigured period of time and then retrieving for each agent related to the collected agents schedule a real-time activity state; and checking adherence of each agent related to the collected agents schedule based on the retrieved real-time activity state to yield the list of agents which are out of adherence.

According to some embodiments of the present disclosure, the agent inactivity detection module, such as agent work time detection module 310 may further operate an eligibility checker module, such as eligibility checker process 325 for each agent in the list of agents, which are out of adherence to yield the list of agents for work-time reconciliation.

According to some embodiments of the present disclosure, the eligibility checker module, such as eligibility checker process 325 for each agent in the list of agents, which are out of adherence may retrieve data from a Workforce Management (WFM) database, such as WFM database 350 to check each agent in the list of agents which are out of adherence to yield a list of agents which are out of adherence more than a preconfigured threshold amount of time and then check each agent in the list of agents which are out of adherence more than a preconfigured threshold amount of time to yield a list of agents that their schedule has ended and then check each agent in the list of agents that their schedule has ended to yield a list of agents that their last real-time activity state is other than logout.

According to some embodiments of the present disclosure, the eligibility checker module, such as eligibility checker process 325, may mark the list of agents that their last real-time activity state is other than ‘logout’ as included in the list of agents for work-time reconciliation.

According to some embodiments of the present disclosure, the eligibility checker module, such as eligibility checker process 325, may return the list of agents for work-time reconciliation to the agent inactivity detection module, such as agent work time detection module 310.

According to some embodiments of the present disclosure, agent inactivity detection module, such as agent work time detection module 310, may invoke a reconciliation module, such as reconciliation module 340 or such as work-time reconciliation module 450 in FIG. 4, with the list of agents who have forgotten to perform the logout action in system, i.e., the list of agents for work-time reconciliation.

According to some embodiments of the present disclosure, the reconciliation module, such as reconciliation module 340 or such as work-time reconciliation module 450 in FIG. 4, may perform logout patching process 330 for each agent in the list of agents for work-time reconciliation the logout time may be marked according to the agent schedule end time.

According to some embodiments of the present disclosure, the reconciliation module, such as reconciliation module 340 or such as work-time reconciliation module 450 in FIG. 4, may correct the activity state of agents in the list of agents for work-time reconciliation to ‘logout’ activity state in the database, such as WFM system database 350.

According to some embodiments of the present disclosure, the reconciliation module, such as reconciliation module 340 or such as work-time reconciliation module 450 in FIG. 4, may enable report generation and persistence process 335 to persist data of the agents who were logged off, i.e., agents for work-time reconciliation, in a database, such as the WFM database 350. Furthermore, the reconciliation module, such as reconciliation module 340 or such as work-time reconciliation module 450 in FIG. 4 may generate a report 320, such as the example of an agent activity reconciliation report 500 in FIG. 5.

FIG. 4 schematically illustrates a high-level diagram of a computerized system 400 for work-time reconciliation upon agent inactivity prediction, in accordance with some embodiments of the present disclosure.

According to some embodiments of the present disclosure, an agent inactivity detection module, such as agent inactivity detection module 410 may continuously run a process which may receive real-time agent activity state information from a system, such as a contact center Automatic Calls Distributer (ACD) system 430. The agent inactivity detection module, such as agent inactivity detection module 410 may interact with a database, such as Workforce Management (WFM) database 440 which may be a relational database and a database such as in memory database 460 to fetch information of agent's current activity state and working shift details, i.e., schedule start time and end time. The agent inactivity detection module, such as agent inactivity detection module 410 may operate validations to detect agent inactivity, such as eligibility checker process 325 in FIG. 3 and may invoke a reconciliation process, such as work-time reconciliation module 450 or such as reconciliation module 340 in FIG. 3.

According to some embodiments of the present disclosure, the reconciliation process, such as work-time reconciliation module 450 or such as reconciliation module 340 in FIG. 3 may feed the processed data to a reconciliation report screen, such as reconciliation report 420 via a display unit 470, which will be added as part of a WFM User Interface (UI) where a user such as an agent's supervisor 475 may check which agent's working activity is corrected in a report, such as reconciliation report 420 or such as agent activity reconciliation report 500 in FIG. 5.

FIG. 5 shows an example of an agent activity reconciliation report 500, in accordance with some embodiments of the present disclosure.

According to some embodiments of the present disclosure, a work-time reconciliation module, such as work-time reconciliation module 150 or such as reconciliation module 340 in FIG. 3 or such as work-time reconciliation module 450 may display, on a display unit, such as display unit 470 in FIG. 4, details of agents in a list of agents for work-time reconciliation. The list of agents for work-time reconciliation may be a reconciliation report, such as reconciliation report 420 in FIG. 4 or such as report 320 in FIG. 3

According to some embodiments of the present disclosure, details of agents in the list of agents for work-time reconciliation may be displayed for a specified time. For example, in the past 30 days 520.

According to some embodiments of the present disclosure, the displayed details of agents in the list of agents for work-time reconciliation may include at least one of: (i) agent's identification; (ii) a number of reconciliations in a predefined period of time; (iii) activity correction duration; and (iv) one or more dates of reconciliations.

According to some embodiments of the present disclosure, for example 510a, during the past 30 days 520, for agent's identification ‘1001’, the displayed number of reconciliations in a predefined period of time is ‘4’ and the activity correction duration is two hours. The one or more dates of reconciliations are: Mar. 20, 2021, Mar. 18, 2021, Mar. 15, 2021, Mar. 11, 2021, which means that during these dates the agent ‘1001’ has forgotten to logout four times and the work-time reconciliation module, such as work-time reconciliation module 150 in FIG. 1B, or such as reconciliation module 340 in FIG. 3 or such as work-time reconciliation module 450 may detect the logout failures and correct the end time of all four related schedules in the database, such as WFM database 350 in FIG. 3 or WFM database 440 in FIG. 4, thus correcting a total of two hours.

According to some embodiments of the present disclosure, for example 510b, during the past 30 days, for agent's identification ‘1022’, the displayed number of reconciliations in a predefined period of time is ‘2’ and the activity correction duration is two hours. The one or more dates of reconciliations are: Mar. 22, 2021, Mar. 17, 2021, which means that during these dates the agent ‘1022’ has forgotten to logout twice and the work-time reconciliation module, such as work-time reconciliation module 150 in FIG. 1B, or such as reconciliation module 340 in FIG. 3 or such as work-time reconciliation module 450 may detect the logout failures and correct the end time the related two schedules in the database, such as WFM database 350 in FIG. 3 or WFM database 440 in FIG. 4, thus correcting a total of one hour.

According to some embodiments of the present disclosure, for example 510c, during the past 30 days, for agent's identification ‘1048’, the displayed number of reconciliations in a predefined period of time is ‘5’ and the activity correction duration is two hours and a half. The one or more dates of reconciliations are: Mar. 21, 2021, Mar. 15, 2021, Mar. 13, 2021, Mar. 10, 2021, Mar. 8, 2021, which means that during these dates the agent ‘1048’ has forgotten to logout five times and the work-time reconciliation module, such as work-time reconciliation module 150 in FIG. 1B, or such as reconciliation module 340 in FIG. 3 or such as work-time reconciliation module 450, may detect the logout failures of the agent and correct the end time of all related five schedules, thus correcting a total of two hours and a half.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for work-time reconciliation upon agent inactivity prediction, the computerized-method comprising:
in a computerized system comprising a processor, a data storage of data related to workforce-management and a data storage of data relate to interaction-routing; and a memory to store the data storages, said processor is configured to operate a work-time reconciliation module, said operating of said work-time reconciliation module comprising:
(i) operating an agent inactivity detection module to yield a list of agents for work-time reconciliation;
(ii) storing the list of agents for work-time reconciliation in the data storage of data related to workforce management; and
(iii) displaying on a display unit details of agents in the list of agents for work-time reconciliation.

2. The computerized-method of claim 1, wherein the operating of the work-time reconciliation module is further comprising: correcting a logout-time of each agent in the list of agents for work-time reconciliation in the data storage of data related to workforce management based on agent schedule details, wherein the agent schedule details are retrieved from the data storage of data related to work-force management.

3. The computerized-method of claim 1, wherein the operating of the agent inactivity detection module comprising:
(i) operating a service provider module to receive a list of agents which are out of adherence; and
(ii) operating an eligibility checker module for each agent in the list of agents which are out of adherence to yield the list of agents for work-time reconciliation.

4. The computerized-method of claim 3, wherein the operating of the service provider module comprising:
(i) collecting agents schedule of a preconfigured period of time;
(ii) retrieving for each agent related to the collected agents schedule a real-time activity state; and
(iii) checking adherence of each agent related to the collected agents schedule based on the retrieved real-time activity state to yield the list of agents which are out of adherence.

5. The computerized-method of claim 4, wherein the checking adherence of each agent related to the collected agents schedule based on the retrieved real-time activity state is performed by comparing the real-time activity state of each agent to at least one of activity states: ‘on-call’, ‘login’, ‘bio-break’, ‘lunch-break’, ‘logout’, ‘meeting’, ‘after call work’, ‘call ended’, ‘call on hold’, ‘email’, ‘chat’, ‘training’, ‘call transfer’, ‘available’, ‘inbound call’, ‘outbound call’ and any other activity state.

6. The computerized-method of claim 3, wherein the operating of the eligibility checker module comprising:
(i) checking each agent in the list of agents which are out of adherence to yield a list of agents which are out of adherence more than a preconfigured threshold amount of time;
(ii) checking each agent in the list of agents which are out of adherence more than a preconfigured threshold amount of time to yield a list of agents that their schedule has ended;
(iii) checking each agent in the list of agents that their schedule has ended to yield a list of agents that their last real-time activity state is other than logout; and
(iv) marking the agents in the list of agents that their last real-time activity state is other than ‘logout’ as included in the list of agents for work-time reconciliation.

7. The computerized-method of claim 1, wherein the displayed details of agents in the list of agents for work-time reconciliation include at least one of: (i) agent's identification; (ii) a number of reconciliations in a predefined period of time; (iii) activity correction duration; and (iv) one or more dates of reconciliations.

8. A computerized-system for work-time reconciliation upon agent inactivity prediction, the computerized-system comprising:
a processor,
a data storage of data related to workforce-management and a data storage of data relate to interaction-routing; and a memory to store the data storages, said processor is operating a work-time reconciliation module, said operating of the work-time reconciliation module is configured to:
(i) operate an agent inactivity detection module to yield a list of agents for work-time reconciliation;
(ii) store the list of agents for work-time reconciliation in the data storage of data related to workforce management; and
(iii) display on a display unit details of agents in the list of agents for work-time reconciliation.

9. The computerized-system of claim 8, wherein the operating of the work-time reconciliation module is further comprising: correcting a logout-time of each agent in the list of agents for work-time reconciliation in the data storage of data related to workforce management.

10. The computerized-system of claim 8, wherein the operating of the agent inactivity detection module comprising:
(i) operating a service provider module to receive a list of agents which are out of adherence; and
(ii) operating an eligibility checker module for each agent in the list of agents which are out of adherence to yield the list of agents for work-time reconciliation.

11. The computerized-system of claim 10, wherein the operating of the service provider module comprising:
(i) collecting agents schedule of a preconfigured period of time;
(ii) retrieving for each agent related to the collected agents schedule a real-time activity state; and
(iii) checking adherence of each agent related to the collected agents schedule based on the retrieved real-time activity state to yield the list of agents which are out of adherence.

12. The computerized-system of claim 11, wherein the checking adherence of each agent related to the collected agents schedule based on the retrieved real-time activity state is performed by comparing the real-time activity state of each agent to at least one of activity states: ‘on-call’, ‘login’, ‘bio-break’, ‘lunch-break’, ‘logout’, ‘meeting’, ‘after call work’, ‘call ended’, ‘call on hold’, ‘email’, ‘chat’, ‘training’, ‘call transfer’, ‘available’, ‘inbound call’, ‘outbound call’ and any other activity state.

13. The computerized-system of claim 10, wherein the operating of the eligibility checker module comprising:
(i) checking each agent in the list of agents which are out of adherence to yield a list of agents which are out of adherence more than a preconfigured threshold amount of time;
(ii) checking each agent in the list of agents which are out of adherence more than a preconfigured threshold amount of time to yield a list of agents that their schedule has ended;
(iii) checking each agent in the list of agents that their schedule has ended to yield a list of agents that their last real-time activity state is other than logout; and
(iv) marking the agents in the list of agents that their last real-time activity state is other than ‘logout’ as included in the list of agents for work-time reconciliation.

14. The computerized-system of claim 8, wherein the displayed details of agents in the list of agents for work-time reconciliation include at least one of: (i) agent's identification; (ii) a number of reconciliations in a predefined period of time; (iii) activity correction duration; and (iv) one or more dates of reconciliations.
